(19) United States
(12) Patent Application Publication
(10) Pub. No.: US 2005/0268599 A1
(43) Pub. Date: Dec. 8, 2005

(54) Air-fuel ratio control device for internal combustion engine

(75) Inventors: Teruaki Kawakami, Tokyo (JP); Keiichi Enoki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 11/005,014

(22) Filed: Dec. 7, 2004

(30) Foreign Application Priority Data
Jun. 2, 2004 (JP) P2004-164748

(51) Int. Cl. F01N 3/00; F02M 1/00

(52) U.S. Cl. 60/285

(57) ABSTRACT

An air-fuel ratio control device of the present invention is equipped with an upstream side air-fuel ratio sensor which is disposed in a passage at the upstream side of a three way catalyst and detects an air-fuel ratio of an engine, a downstream side air-fuel ratio sensor which is disposed in a passage at the downstream side of the three way catalyst and detects an air-fuel ratio after passing through the three way catalyst, and ECU. ECU is equipped with downstream air-fuel ratio sensor output phase advance calculating means for carrying out phase advance caluculation on an output of the downstream side air fuel ratio sensor, a target upstream air-fuel ratio calculating means for calculating a target upstream air-fuel ratio so that the output of the downstream air-fuel ratio sensor output phase advance calculating means is coincident with a target downstream air-fuel ratio, air-fuel ratio correction amount calculating means for calculating an air-fuel ratio correction amount so that an upstream air-fuel ratio is coincident with the target upstream air-fuel ratio, and fuel injection amount adjusting means for adjusting a fuel injection amount in accordance with the air-fuel ratio correction amount.

### BACKGROUND OF THE INVENTION

1. Field of the Invention

The present invention relates to an air-fuel ratio control device for an internal combustion engine for adjusting a fuel injection amount by equipping an air-fuel ratio sensor at the upstream side and the downstream side of a three way catalyst and combining air-fuel ratio feedback at the upstream side with air-fuel ratio feedback at the downstream side.

2. Description of the Related Art

A present gasoline-powered vehicle is equipped with a three way catalyst as an exhaust gas cleaning system. The three way catalyst has noble metal such as Pt (Platinum), Pd (Palladium), Rh (Rhodium) carried thereon, and functions to convert harmful gas components (HC, NOₓ, CO) of the vehicle to harmless gas by catalytic action. In order to bring out the catalytic action, it is important to keep the exhaust gas to a theoretical air-fuel ratio. Ceria serving as assistant catalyst absorbs/desorbs oxygen in accordance with a surrounding atmosphere and keeps the oxygen concentration to a constant value (this is called as oxygen storage capacity), and thus it takes a role of absorbing variation of the air-fuel ratio and keeping the inside of the catalyst to a theoretical air-fuel ratio (stoichiometric).

It is well known that a relationship as shown in FIG. 9 exists between the air-fuel ratio and the catalytic conversion efficiency, and air-fuel ratio feedback is carried out in order to keep the air-fuel ratio at the upstream side in the vicinity of the theoretical air-fuel ratio. In a general air-fuel feedback system, an air-fuel ratio sensor (oxygen concentration sensor) is secured at a place in an exhaust system which is possibly nearest to a combustion chamber, that is, at the upstream side of the three way catalyst to carry out feedback control on the fuel injection amount of the engine so that the combustion gas has a theoretical air-fuel ratio. Furthermore, a double air-fuel ratio sensor system in which an air-fuel ratio sensor is also secured at the downstream side of the three way catalyst to compensate for dispersion of the air-fuel ratio sensor at the upstream side and degradation with time lapse has been already proposed in JP-A-58-48756 (hereinafter referred to as “Patent Document 1”).

Furthermore, in the case of fuel cut, a large amount of exhaust gas containing oxygen flows into catalyst unlike a normal air-fuel ratio feedback operation, so that the oxygen storage capacity possessed by the three way catalyst is saturated and thus NOₓ cleaning rate is greatly lowered. Therefore, JP-A-5-26076 (hereinafter referred to as Patent Document 2) has proposed that, at the restoration time from the fuel cut stale, a control constant for λ feedback control during a period until the signal of the air-fuel ratio sensor at the downstream side (hereinafter referred to as “downstream air-fuel ratio sensor”) is switched to a rich detection state is set to be offset to the rich side to correct the oxygen storage capacity to a proper value.

According to the method disclosed in the Patent Document 1, the air-fuel ratio sensor at the downstream side is used to correct degradation of the air-fuel ratio sensor at the upstream side (hereinafter referred to as “upstream air-fuel ratio sensor”), and thus the feedback of the downstream air-fuel ratio sensor is late. Therefore, as shown in FIG. 12, even when a rear λ sensor output is inverted to a lean side, variation of the air-fuel ratio (A/F) at the upstream side of the catalyst is late because correction of an injection amount is late, so that the catalytic conversion efficiency to NOₓ is lowered. Accordingly, it has been difficult to keep the catalytic conversion efficiency to the maximum level.

Furthermore, according to the method disclosed in the Patent Document 2, as shown in FIG. 13, if fuel amount increasing correction is released after the rear λ sensor is inverted to a rich output side, a great phase delay occurs in the exhaust system and the catalyst and thus the air-fuel ratio in the catalyst becomes rich, so that the CO cleaning rate may be lowered.

### SUMMARY OF THE INVENTION

The present invention has been implemented to solve the problem of the conventional device described above, and has an object to provide an air-fuel ratio control device for an internal combustion engine which can bring out the catalytic performance at maximum by enhancing the feedback performance of the air-fuel ratio at the downstream side.

In order to attain the above object, an air-fuel ratio control device for an internal combustion engine according to the invention comprises a three way catalyst equipped in an exhaust passage of the internal combustion engine, an upstream side air-fuel ratio sensor which is equipped in a passage at the upstream side of the three way catalyst and detects the air-fuel ratio of the engine, a downstream side air-fuel ratio sensor which is equipped in a passage at the downstream side of the three way catalyst and detects the air-fuel ratio after the three way catalyst, downstream air-fuel ratio sensor output phase advance calculating means for carrying out phase advance calculation on an output of the downstream side air fuel ratio sensor, target upstream air-fuel ratio calculating means for calculating a target upstream air-fuel ratio so that the output of the downstream air-fuel ratio sensor output phase advance calculating means is coincident with a target downstream air-fuel ratio, air-fuel ratio correcting amount calculating means for calculating an air-fuel ratio correcting amount so that the upstream air-fuel ratio is coincident with a target upstream air-fuel ratio, and fuel injection amount adjusting means for adjusting a fuel injection amount in accordance with the air-fuel ratio correcting amount.

According to the present invention, by subjecting the output of the downstream air-fuel ratio sensor output to phase advance processing, and there can be achieved an air-fuel ratio control device for an internal combustion engine in which the phase delay is ameliorated in the rear λ feedback system, and the catalytic conversion efficiency can be dynamically kept to the highest level.

### BRIEF DESCRIPTION OF THE DRAWINGS

FIG. 1 is a diagram showing the construction of an air-fuel ratio control device for an internal combustion engine according to a first embodiment of the present invention;

FIG. 2 is a diagram showing the relationship between a rear λ sensor output to downstream air-fuel ratio and gas concentration after passing through catalyst;

FIG. 3 is a control block diagram showing a control system for the air-fuel ratio control device for the internal combustion engine according to the first embodiment of the present invention;

FIG. 4 is a flowchart showing a rear λ feedback operation routine in the first embodiment of the present invention;

FIG. 5 is a flowchart showing a front A/F feedback operation routine in the first embodiment of the present invention;

FIG. 6 is a flowchart showing a fuel-cut restoration amount-increase operation routine in the first embodiment of the present invention;

FIG. 7 is a diagram showing an example of a P-term correction amount table in the first embodiment;

FIG. 8 is a diagram showing an example of an I-term correction amount table in the first embodiment of the present invention;

FIG. 9 is a diagram showing the well-known relationship between an upstream air-fuel ratio and a catalyst conversion efficiency;

FIG. 10 is an operating diagram of the air-fuel ratio control device for the internal combustion engine in the first embodiment of the present invention;

FIG. 11 is an operating diagram when the fuel-cut restoration amount-increasing correction is carried out in the first embodiment of the present invention; and

FIG. 12 is a diagram showing the operation of a conventional device.

### DETAILED DESCRIPTION OF THE PREFERRED EMBODIMENTS

Preferred embodiments according to the present invention will be described hereunder with reference to the accompanying drawings.

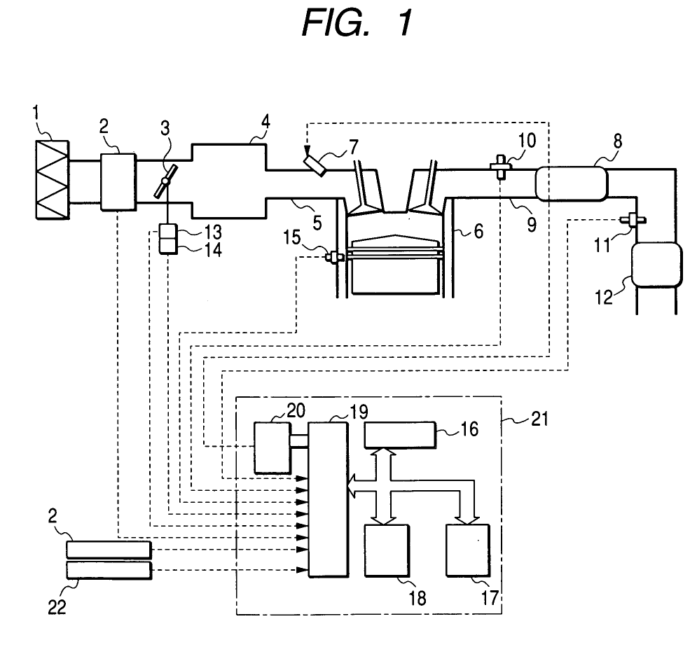

FIG. 1 is a diagram showing the overall construction when an air-fuel ration control device according to a first embodiment of the present invention is applied to an internal combustion engine for a vehicle.

In FIG. 1, reference numeral 1 represents an air cleaner and it has a filter for removing dust contained in air sucked into an air intake passage. Reference numeral 2 represents an air flow sensor such as a hot-wire air flow sensor or the like, and it generates a voltage signal corresponding to an intake air amount. Reference numeral 3 represents a throttle valve, and it is interlocked with an acceleration pedal (not show) to adjust the intake air amount. Reference numeral 4 represents a surge tank, and reference numeral 5 represents an intake pipe connected to an intake air port of the engine main body 6. The intake pipe 5 is connected to the air intake passage through the surge tank 4. Reference numeral 9 represents an exhaust pipe connected to an exhaust port of the engine main body 6. Furthermore, a throttle valve opening degree sensor 13 which contains a potentiometer and detects the opening degree of the throttle valve is equipped in the vicinity of the throttle valve 3. Reference numeral 14 represents an idle switch and detects a fully-closed state of the throttle valve 3.

The fuel injection valve 7 is equipped every cylinder of the intake pipe 5, and it opens in response to a signal of ECU (Engine Control Unit) 21 to inject pressurized fuel to the air intake port of each cylinder. The injection amount control on the fuel injection valve 7 will be described later.

The exhaust pipe 9 is equipped with a front catalyst converter 8 and a rear catalyst converter 12 at the downstream side of the front catalyst converter 8. Each catalyst converter contains a three way catalyst, and can simultaneously clean up three components of HC, NOₓ and CO in exhaust gas. Furthermore, an upstream side air-fuel ratio sensor (hereinafter referred to as “linear A/F sensor”) 10 is equipped at the upstream side of the front catalyst converter 8 to detect the upstream air-fuel ratio on the basis of the concentration of oxygen contained in the exhaust gas. Furthermore, a downstream side air-fuel ratio sensor (hereinafter referred to as “rear λ sensor”) 11 is equipped at the downstream side of the front catalyst converter 8, and generates a rich/lean voltage in accordance with the oxygen concentration.

A crank angle sensor 22 outputs a pulse signal every time the crank shaft of the engine 6 is rotated by a constant rotational amount. A cam angle sensor 23 outputs a pulse signal every time the cam shaft of the engine 6 is rotated by a constant rotational amount. For example, the crank angle sensor 22 outputs a rotational angle detecting pulse for every crank rotational angle of 10°.

The cam angle sensor 23 outputs a different signal every cylinder, and thus each cylinder can be specified in combination of the signal from the cam angle sensor 23 and the signal from the crank angle sensor 22. Furthermore, a water temperature sensor 15 for outputting a voltage signal in accordance with an engine cooling water temperature is provided to a water jacket of a cylinder block of the engine 6.

ECU 21 is equipped in a vehicle room, and ECU 21 comprises a central processing unit 16, ROM 17, RAM 18, an input/output interface 19 and a driving circuit 20. Various kinds of sensors and a switch group are connected to the input side of ECU 21 in addition to the above elements. The outputs of the various kinds of sensors are subjected to A/D conversion through an interface and then taken into ECU. Furthermore, various kinds of actuators such as an ignition coil, an ISC valve, etc. (not shown) are connected to the output side of ECU 21 in addition to the injection valve 7. ECU 21 outputs processed results based on the detection information of the various kinds of sensors and the switch group to control the actuators.

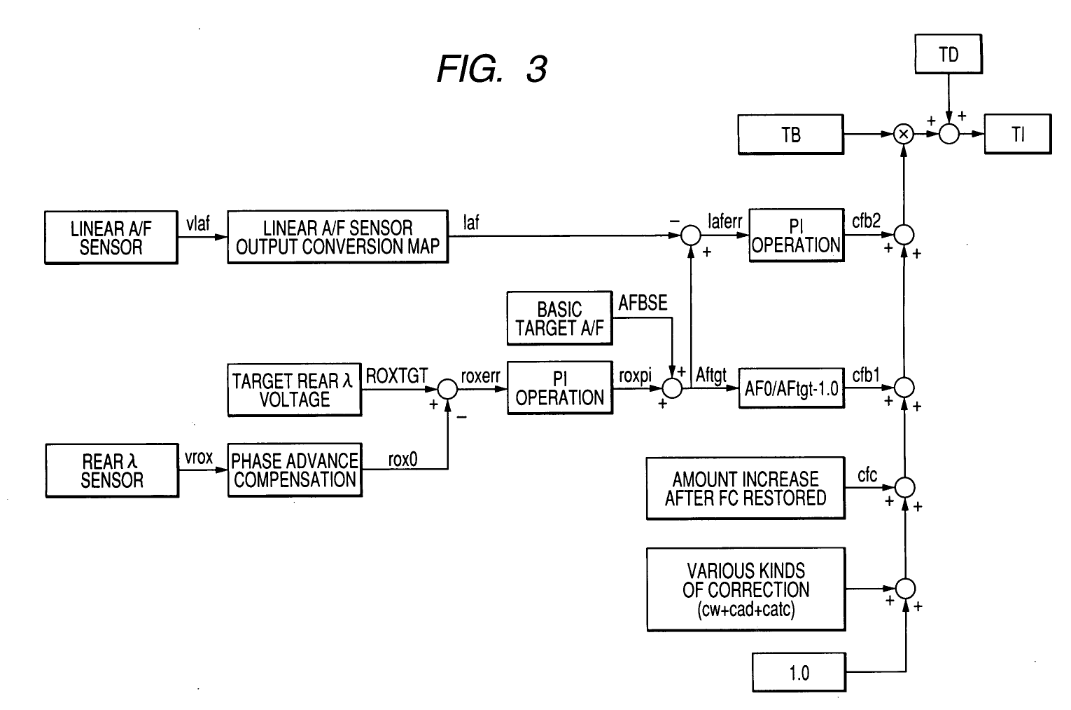

Next, the fuel injection control according to the first embodiment will be described with reference to FIG. 3.

ECU 21 subjects the output of the air flow sensor 2 to A/D conversion and reads the A/D-converted result therein, and integrates the intake air amount in the signal section of the crank angle sensor 22 to calculate an intake air amount A/N0 per intake stroke. In order to simulate response delay in the surge tank 4, a primary filter is applied to the intake air amount A/N0 to calculate the intake air amount A/N injected into the cylinder.

A basic fuel injection time TB is calculated so that a theoretical air-fuel ratio is achieved for A/N thus achieved. Furthermore, a warming correction amount cw based on the water temperature sensor 15, an acceleration correction amount cad based on the throttle valve opening degree sensor 13 and other various kinds of fuel correction amounts cetc are calculated.

Next, the air-fuel ratio feedback will be described.

ECU 21 reads in the signals of the linear A/F sensor 10 and the rear λ sensor 11 every predetermined period (for example, 5 ms) while subjecting these signals to A/D conversion. The linear A/F sensor output: vlaf is converted to an actual air-fuel ratio: laf on the basis of a linear A/F sensor output conversion map stored in ROM 17 in advance. Then, the deviation from a target A/F:Aftgt described later is calculated and PI operation is carried out to calculate a correction amount:cfb2.

The rear λ sensor output:vrox is subjected to phase advance operation to achieve a phase-advance-processed rear λ sensor output: rox0, and then the deviation roxerr between the phase-advance-processed rear λ sensor output and a target rear λ voltage ROXTGT is calculated. PI operation is carried out from the deviation:roxerr, and a preset basic target A/F:AFBSE is corrected to calculate a target A/F: Aftgt. A fuel correction amount: cfb1 is calculated from the target A/F: Aftgt. If no external disturbance is applied to A/F, the actual A/F is coincident with the target A/F by cfb1. However, if external disturbance is applied, the actual A/F can be corrected to the target A/F by cfb2.

Since no combustion is carried out under fuel cut, air containing a large amount of oxygen flows into the catalyst, and the air-fuel ratio in the catalyst is kept under a lean state for a little because of oxygen storage capacity of the catalyst even after restored from fuel cut. It is difficult to compensate for this state by only the air-fuel ratio feedback. Therefore, the fuel amount increasing correction: cfc is carried out until the phase-advance-processed rear λ sensor output is reversed to the rich side.

The basic fuel injection time TB is corrected by using the correction amount thus achieved. Furthermore, an invalid injection time TD for correcting the valve-opening delay time of the fuel injection valve 7 is added to calculate the actual fuel injection pulse time TI, and then the fuel injection valve 7 is driven through the driving circuit 20.

According to the construction described above, the rear sensor output is subjected to the phase advance processing, and thus the response delay in the exhaust system and the catalyst can be compensated. Furthermore, the fuel amount increasing correction after the fuel cut can be properly carried out, and the catalyst conversion efficiency can be kept to the maximum level at all times.

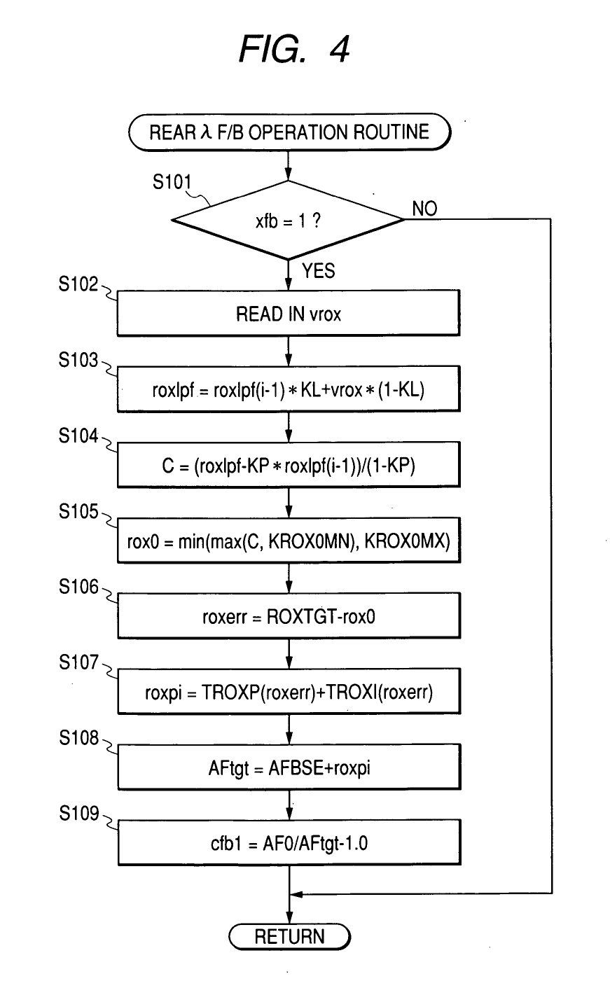

The air-fuel ratio feedback correction will be described in detail with reference to a flowchart. FIG. 4 shows a rear λ feedback operation routine.

First, if an air-fuel ratio feedback execution flag is set (xfb=1) in step S101, the rear λ feedback operation is carried out. If it is not set (xfb≠1), the operation concerned is not carried out, and the processing returns to the main routine. The air-fuel ratio feedback execution flag is set through a judgment based on the engine water temperature or the rotational number/load condition. Under the fuel cut operation, no air-fuel ratio feedback execution flag is set.

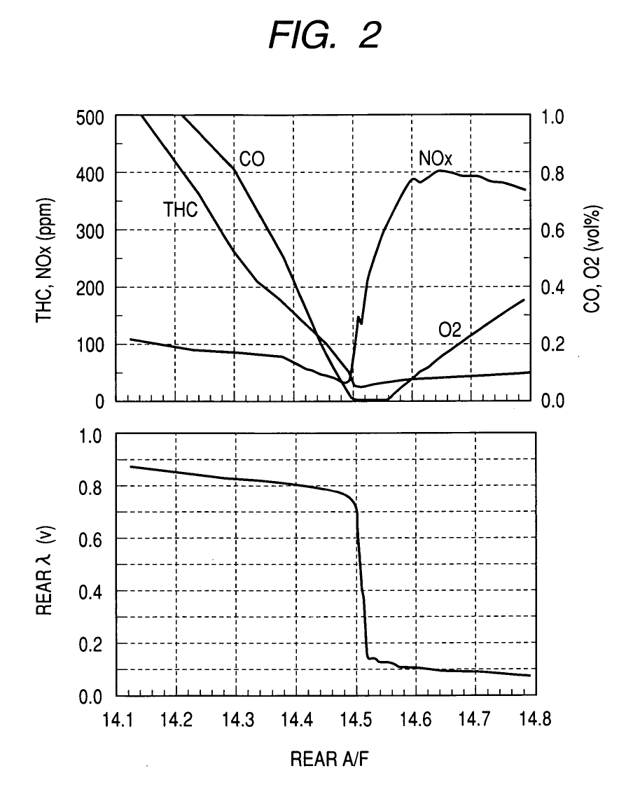

Next, the rear λ sensor output is read in in step S102, and a low pass filter operation is carried out in step S103. KL represents a low pass gain and satisfies 0≦KL≦1. (i−1) represents a preceding value. In step S104, the phase-advance operation is carried out. KP represents a phase-advance gain, and satisfies 0≦KP≦1. KL and KP are set so that the signal phase is preferably advanced while the noise components of the rear λ sensor output are removed. In step S105, the minimum value KROXOMN and the maximum value KROXOMX are equipped for the result achieved in step S104 so that the phase-advance calculation value does not exceed the possible maximum value of an actual rear λ output. For example, as is apparent from FIG. 2 showing the relationship between gas after passing through catalyst and the rear λ sensor output, the after-catalysis gas concentration is lowered when the rear λ feedback works, so that the actual rear λ sensor output takes only the values from 0.1 to 0.9V. Accordingly, the minimum value KROXOMN and the maximum value KROXOMX are set so that KROXOMN=0.1 and KROXOMN=0.9.

In step S106, the deviation roxerr between the target rear λ voltage ROXTGT and the phase-advance-processed rear λ output rox0 is calculated, and PI operation is carried out in step S107.

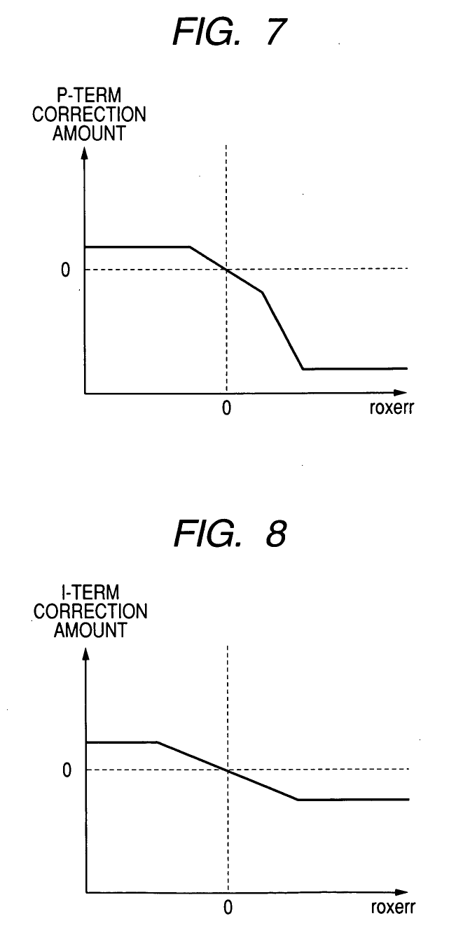

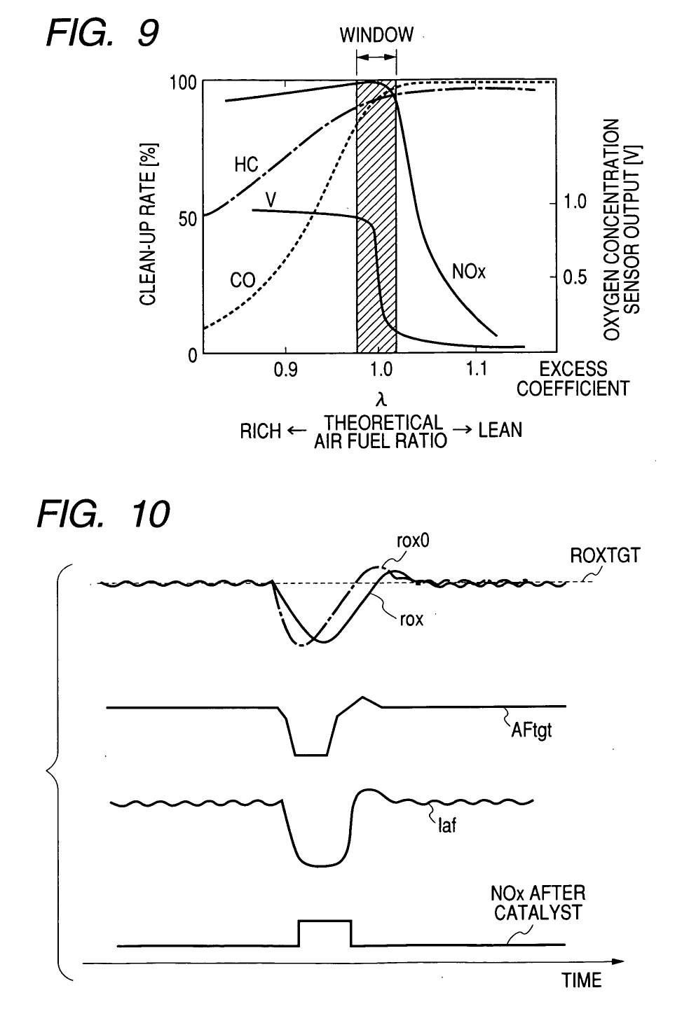

Here, in a P-term operation, as the deviation roxerr is larger than a predetermined value, greater correction is carried out like a P-term correction amount table TROXP shown in FIG. 7.

Accordingly, as shown in FIG. 10, when the rear λ sensor output:rox starts to decrease, the phase-advance-processed rear λ output: rox0 starts to decrease earlier than the actual value. Since the deviation roxerr is calculated from the phase-advance-processed rear λ output rox0 and the target rear λ voltage: ROXTGT, the correction can be carried out earlier than the actual rear λ sensor output rox. Furthermore, when the deviation is small, the correction amount is small in the PI operation. However, when the deviation exceeds a predetermined value, the P-term calculation correction amount is increased, and thus when the phase-advance-processed rear λ output: rox0 is more greatly deviated from the predetermined value to the lean side as compared with the target rear λ voltage: ROXTGT as shown in FIG. 10, the target A/F: Aftgt is greatly corrected to the rich side.

In the I-term operation, the relationship between the deviation roxerr and the correction amount is linearly set to a relatively small gain as in the case of an I-term correction amount table shown in FIG. 8. This is because the catalyst oxygen storage capacity works like an integrator and thus if the I-term correction amount is also set to a large value, it would rather induce hatching. The setting as described above can make proper the oxygen storage capacity saturated in the catalyst and keep the catalyst conversion efficiency to the maximum level.

In step S108, the basic target A/F: AFBSE is corrected on the basis of the target A/F correction amount roxpi achieved in the PI operation of the rear λ feedback to achieve the target A/F: AFtgt.

Finally, in step S109, the fuel correction amount to the basic fuel injection time TB is calculated, and then the processing returns to the main routine. Here, AF0 represents the theoretical air-fuel ratio, and for example AF0 is set to 14.7.

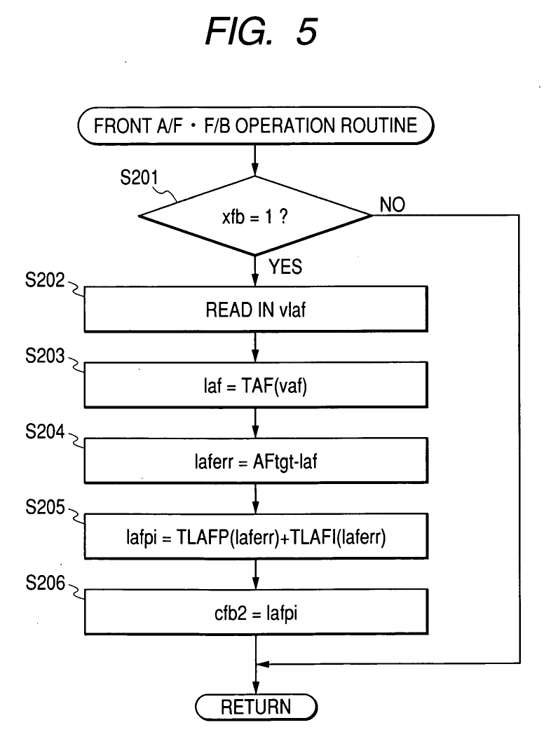

Next, in the front A/F feedback operation routine, it is first judged in step S201 whether the air-fuel ratio feedback is executed or not as shown in FIG. 5.

If the air-fuel feedback is executed, the processing goes to step S202 to read in the linear A/F sensor output vlaf and map-convert it to actual A/F:laf in step S203. Subsequently, the deviation laferr between the target A/F: AFtg and the actual A/F: laf is calculated in step S204, and the PI operation is carried out in step S205. In step S205, the conversion to the fuel correction amount is carried out on the basis of the deviation laferr by a table (not shown), and P-term/I-term are calculated. IN step S206, the PI calculation result lafpi thus achieved is stored in cfb2 and then the processing returns to the main routine.

The result achieved by executing the flowcharts of FIGS. 4 and 5 will be described with reference to FIG. 10.

In the conventional control, even when the rear λ output rox starts to enter the lean state, the correction of the front A/F is delayed and NOx clean-up dramatically decreases, so that most of NOx entering the catalyst is directly discharged from the catalyst after catalysis. However, when the feedback is carried out by using the phase-advance-processed rear λ output rox0, the front A/F: laf starts to enter the rich state at an early stage, and further the P-term correction is rapidly increased, so that the target rear λ voltage ROXTGT can be restored before the NOx clean-up rate is lowered.

Next, the air-fuel ratio control when restored from fuel cut will be described.

As well known, the fuel cut operation is carried out during deceleration and it is the control under which the fuel injection is stopped. Under the fuel cut operation, wasteful fuel which does not contribute to output power can be cut, and thus the fuel can be enhanced without losing drivability. However, when viewed from the catalyst, this operation is a very special condition under which a large amount of oxygen flows in the catalyst. When the fuel cut is executed and the oxygen storage capacity in the catalyst is saturated, the NOx clean-up rate is kept extremely low. Therefore, when restored from the fuel cut operation, it is necessary to carry out special control adapted to this condition.

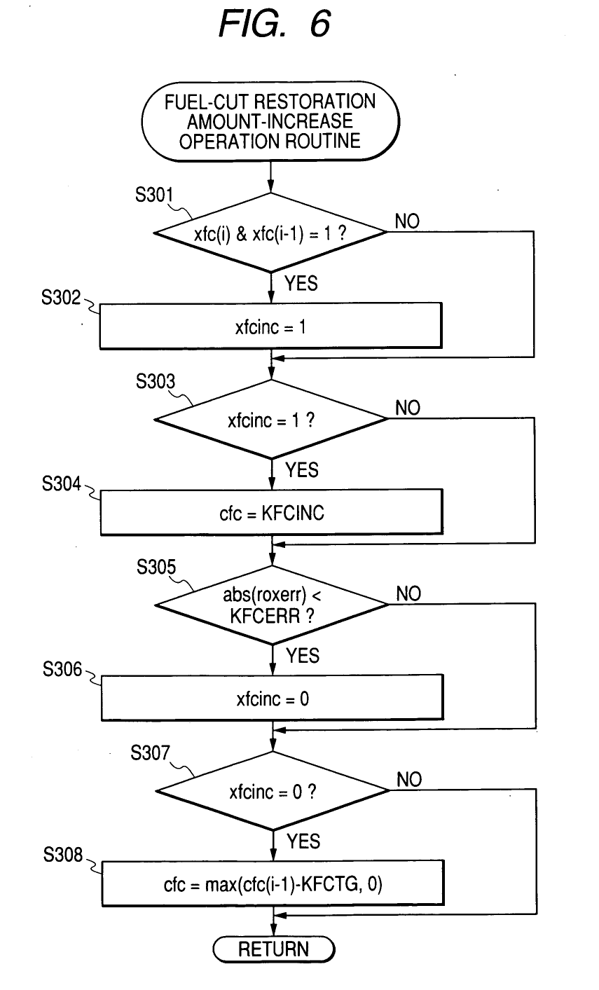

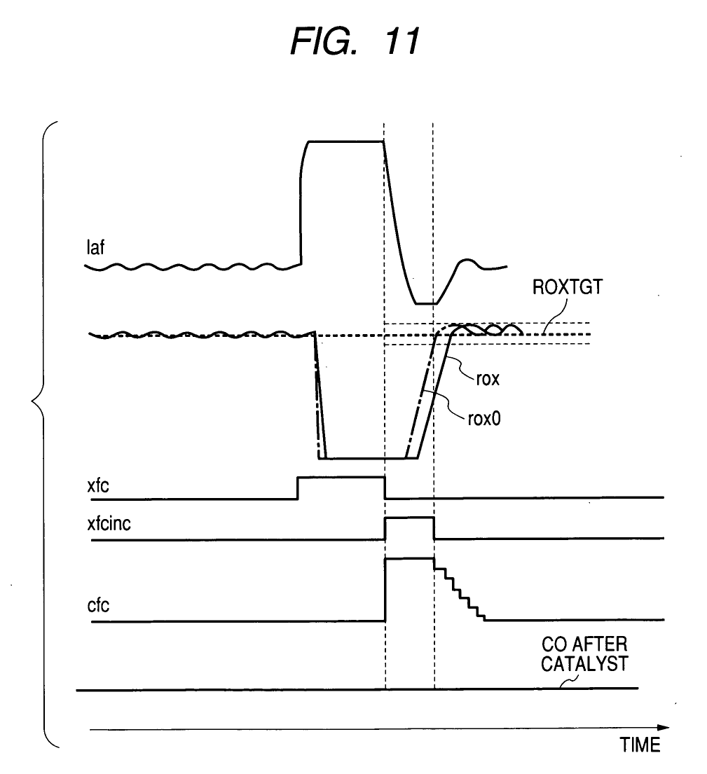

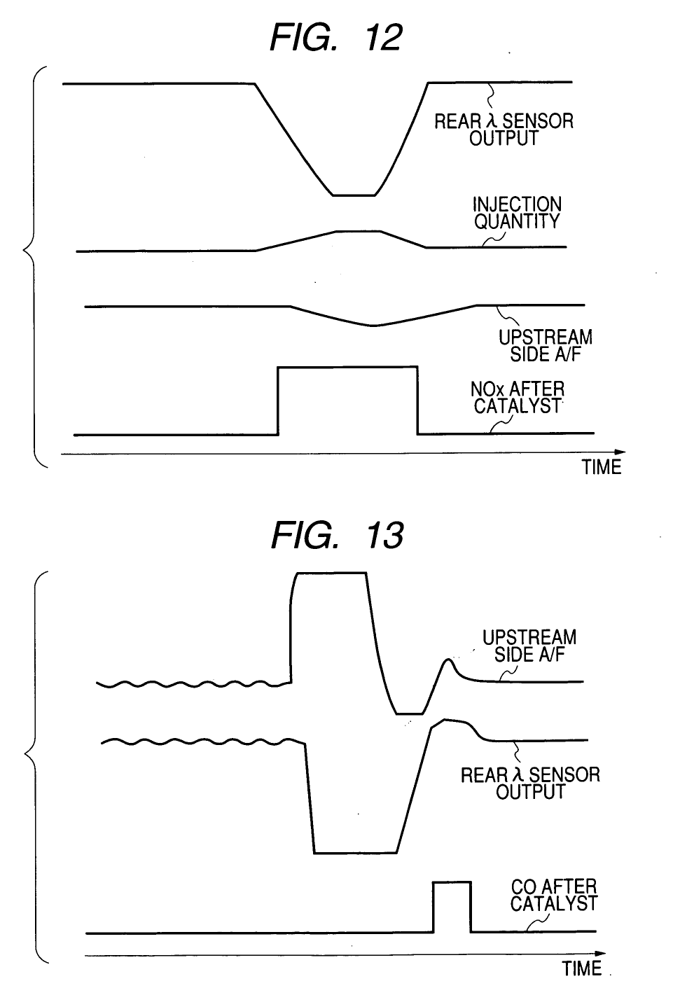

The fuel cut restoration amount-increasing operation routine will be described with reference to FIGS. 6 and 11.

First, the time point of restoration from the fuel cut in step S301, that is, at the time point when the fuel cut flag is switched from the execution-state (xfc=1) to the non-execution state (xfc=0) is detected. When detecting the restoration from the fuel cut, the processing goes to step S302 to set a fuel cut restoration amount-increasing flag (xfcinc=1). In steps S303, S304, the fuel cut restoration amount-increasing correction cfc is continued to be set to predetermined KFCINC during the period of xfcinc=1. If the absolute value of roxerr is reduced to a predetermined value KFCERR or less in steps s305, S306, the fuel cut restoration amount-increasing flag is reset (xfcinc=0).

If the fuel cut restoration amount-increasing flag is reset in steps S307, S308, the fuel cut restoration amount-increasing correction cfc is reduced every predetermined value KFCTG.

As described above, since the correction execution period can be judged by using the phase-advance-processed rear λ sensor output:rox0, the response delay in the exhaust system and the catalyst can be compensated, and the injection amount can be increased by a predetermined amount during the period until the air-fuel ratio in the catalyst is made proper.

As described above in detail, according to the air-fuel ratio control device for the internal combustion engine according to the first embodiment of the present invention, the downstream air-fuel ratio sensor output is subjected to the phase advance processing, whereby the phase delay in the rear λ feedback system can be improved and the catalyst conversion efficiency can be dynamically kept to the highest level.

Furthermore, the maximum value/minimum value clip is provided in the phase advance processing. Therefore, even when the phase advance processing is carried out by using a λ sensor as the downstream air-fuel ratio sensor, there can be avoided such a situation that the correction is excessively great and thus controllability is degraded.

When the downstream air-fuel ratio sensor output is greatly deviated to the lean side from the target downstream air-fuel ratio output, the P-term gain of the rear λ feedback is set so that the target A/F is drastically shifted to the rich state, whereby the oxygen storage amount can be made proper quickly even when the oxygen storage capacity in the catalyst is saturated, and thus NOx deterioration can be prevented.

Furthermore, even when the oxygen storage capacity in the catalyst is saturated under the fuel cut operation, the fuel amount is increased at the restoration time from the fuel cut state to make the upstream air-fuel ratio rich and waste oxygen stored in the catalyst. The fuel cut restoration amount-increasing operation is released on the basis of the phase-advance-processed downstream air-fuel ratio sensor output (i.e., the downstream air-fuel ratio sensor output after the phase advance processing is carried out), so that the oxygen storage capacity can be quickly returned to a proper value. Therefore, no NOx is discharged even under acceleration after restoration from the fuel cut state.

1. An air-fuel ratio control device for an internal combustion engine, comprising:
a three way catalyst equipped in an exhaust passage of the internal combustion engine;
an upstream side air-fuel ratio sensor which is equipped in a passage at the upstream side of the three way catalyst and detects the air-fuel ratio of the engine;
a downstream side air-fuel ratio sensor which is equipped in a passage at the downstream side of the three way catalyst and detects the air-fuel ratio after the three way catalyst;
downstream air-fuel ratio sensor output phase advance calculating means for carrying out phase advance calculation on an output of the downstream side air fuel ratio sensor;
target upstream air-fuel ratio calculating means for calculating a target upstream air-fuel ratio so that the output of the downstream air-fuel ratio sensor output phase advance calculating means is coincident with a target downstream air-fuel ratio;
air-fuel ratio correcting amount calculating means for calculating an air-fuel ratio correcting amount so that the upstream air-fuel ratio is coincident with a target upstream air-fuel ratio; and
fuel injection amount adjusting means for adjusting a fuel injection amount in accordance with the air-fuel ratio correcting amount.

2. The air-fuel ratio control device for internal combustion engine according to claim 1, wherein the downstream air-fuel ratio sensor output phase advance calculating means sets maximum and minimum values in the phase advance calculation in accordance with the downstream side air-fuel ratio sensor.

3. The air-fuel ratio control device for internal combustion engine according to claim 1, wherein the target upstream air-fuel ratio calculating means sets a target upstream air-fuel ratio correction amount to a richer value than usual when the output of the downstream air-fuel ratio sensor output phase advance calculating means is more lean by a predetermined value or more than a target downstream air-fuel ratio.

4. The air-fuel ratio control device for internal combustion engine according to claim 1, further comprising fuel injection amount stopping means for stopping a fuel injection amount under deceleration, fuel-injection restored amount-increasing means for increasing a fuel injection amount just after the fuel injection amount stop is released, and means for stopping the fuel injection amount-increase when the downstream air-fuel ratio phase advance output is within a predetermined deviation of a target downstream air-fuel ratio.
